(19) United States
(12) Patent Application Publication
(10) Pub. No.: US 2008/0201228 A1
(43) Pub. Date: Aug. 21, 2008

(54) Methods and systems to schedule a transaction

(76) Inventors: Christophe Jean Claude Gillet, San Francisco, CA (US); Myra Wong Liu, San Jose, CA (US); Hernan Ignacio Teano, Fremont, CA (US); Stephen Tse, Daly City, CA (US)

Correspondence Address: SCHWEGMAN, LUNDBERG & WOESSNER/EBAY, P.O. BOX 2938, MINNEAPOLIS, MN, 55402, US

(21) Appl. No.: 12/008,520

(22) Filed: Jan. 11, 2008

Related U.S. Application Data
(60) Provisional application No. 60/884,866, filed on Jan. 12, 2007.

(51) Int. Cl. G06Q 30/00; G06F 17/30

(52) U.S. Cl. 705/14; 705/26

(57) ABSTRACT

A system to assist sellers create automated sales for products and services the seller has made available for purchase. The embodiments include receiving sales information that includes data item information that identifies a plurality of data items that are offered for purchase by a seller on a network-based marketplace. The system provides means for scheduling a sale based on the sale information, the sale to begin at a first time and end at a second time, the first time associated with a reduction of a plurality of prices to a plurality of discounted prices. The plurality of prices respectively associated with the plurality of data items. The plurality of discounted prices respectively associated with the plurality of data items and the second time associated with a restoration of the plurality of prices for the plurality of data items.

### CROSS-REFERENCE TO RELATED APPLICATIONS

This patent application claims the benefit of the filing date of U.S. Provisional Patent Application Ser. No. 60/884,866, filed Jan. 12, 2007, and entitled, “METHODS AND SYSTEMS TO SCHEDULE A SALE ON A NETWORK-BASED MARKETPLACE”.

### BACKGROUND

Products have been transacted over the Internet almost since the creation of the Internet. One of the pioneers bringing Internet sales to the forefront was EBAY INC. EBAY INC permits users to list products on website to permit users from all over the world to see the items and make purchases. The users may have a single item that they are offering for purchase or many thousand items offered for purchase. In addition, the items for purchase may be for multiple categories of items from kitchen utensils to automobiles.

Users make items available for purchase often with a buy now price which permits the buyer to purchase the item immediately rather than wait until an auction is run. Often these items may not sell as quickly as the user may desire or for other reasons the user may wish to lower the price of the item. In affect run a sale on the items they are selling on the Internet-based website. Current limitations may require that the user enter each item and edit the price to modify the price for the item. An alternative is to de-list the item and re-list the item for a lower price. This process may be time intensive and in a case where the user would like to place several items on sale at the same time, time consuming.

In some cases a user may wish to have a sale for a set period of time. For example, a Valentines Day sale that may last for two weeks prior to, and end the day after, Valentines Day. In this case the user may not only have to change the price to initiate the sale, but upon the close of the sale, reset the price of the items to the original price.

### BRIEF DESCRIPTION OF THE DRAWINGS

FIG. 1 is a network diagram depicting a system, according to one example embodiment of the present invention, having a client-server architecture.

FIG. 2 is a block diagram illustrating multiple marketplace and payment applications that, in one example embodiment, are provided as part of the network-based marketplace.

FIG. 3 is a high-level entity-relationship diagram, illustrating various tables that may be maintained within the databases, and that are utilized by and support the marketplace and payment applications according to an example embodiment.

FIG. 4 shows a diagrammatic representation of machine in the example form of a computer system within which a set of instructions, for causing the machine to perform any one or more of the methodologies discussed herein, may be executed.

FIG. 5 is a method for setting up and monitoring a sale on a network-based market place according to an example embodiment.

FIG. 6 is a screen shot of a sales creation page according to an example embodiment.

FIG. 7 is an example embodiment listing of products a seller has made available for sale.

FIG. 8 is an example embodiment of a product listing available to a buyer.

FIG. 9 is an example embodiment of a product listing available to a buyer.

FIG. 10 is an error banner utilized to indicate errors in the sale setup according to an example embodiment.

FIG. 11 is a success banner utilized to indicate the successful set up of a sale according to an example embodiment.

FIG. 12 illustrates a preemptive sale ending screen 1200 indicating the result of ending the screen with banner 1210 according to an example embodiment

FIG. 13 is an example embodiment of a product listing available to a buyer.

FIG. 14 is an example embodiment of a screen for managing sales.

### DETAILED DESCRIPTION

Methods and systems to schedule a network-based transaction are described. In the following description, for purposes of explanation, numerous specific details are set forth in order to provide a thorough understanding of the present invention. It will be evident, however, to one skilled in the art that the present invention may be practiced without these specific details.

According to the present disclosure, a system may receive sales information and schedule a sale on a network-based marketplace based on the sales information. The sales information may include item information that includes identifiers that identify items that are offered for sale by a seller on a network-based marketplace. The sales information may include a starting time, and ending time, a sales title and a discount. The item information includes identifiers that identify one or more items that respectively describe goods or services that the seller is offering for sale on the network-based marketplace. In response to receiving the sales information, the system may schedule a sale based on the sales information. For example, the sale may be scheduled to begin at the starting time and end at the ending time. Further, the system may schedule a reduction in price for the identified items based on the discount for the duration of the sale. In one embodiment, the discount may be expressed as a fixed price that is subtracted from the price associated with a particular item. In another embodiment the discount may be expressed as a percentage of a price associated with a particular item. In one embodiment the seller may identify the items using different types of filters. For example, the seller may identify all fixed-price items or fixed-price items in a specified price range or fixed-price items in one or more categories. Further, the seller may identify items by identifying previous sales. For example, the seller may identify a Fall sale to identify that same items to be included in a Christmas sale. Further, the seller may use a search facility to identify items. For example, the search facility may accept search parameters that include keyword(s), categories, price and return search results that identify one or more items. In one embodiment, the seller may schedule multiple sales that are active at the same time. In one embodiment, the seller may edit a sale that is active. For example, the seller may edit the discount or the end date associated with the active sale. In one embodiment, restrictions or listing limitations may restrict a seller's ability to enter sales information or to edit a sale that is in progress. In one embodiment, the restrictions or listing limitations may be geographically (e.g., country) specific. For example, a seller that signs on to the network-based marketplace at a German web site may be restricted from editing a discount that is associated with a sale that is in progress. In contrast, a seller that signs on to the network-based marketplace at a US site may not be restricted from editing a discount that is associated with a sale that is in progress. In response to the scheduled beginning of a sale, the system may update interfaces with promotion information (e.g. apply a “sales treatment”). For example, the promotion information may include a “Sale Logo”, a strikethrough applied to the original price, a discount price, a percentage off, and an optional sale end date. In response to the scheduled end of a sale, the system may update interfaces to remove the promotion information (e.g. apply a “sale treatment”).

### Platform Architecture

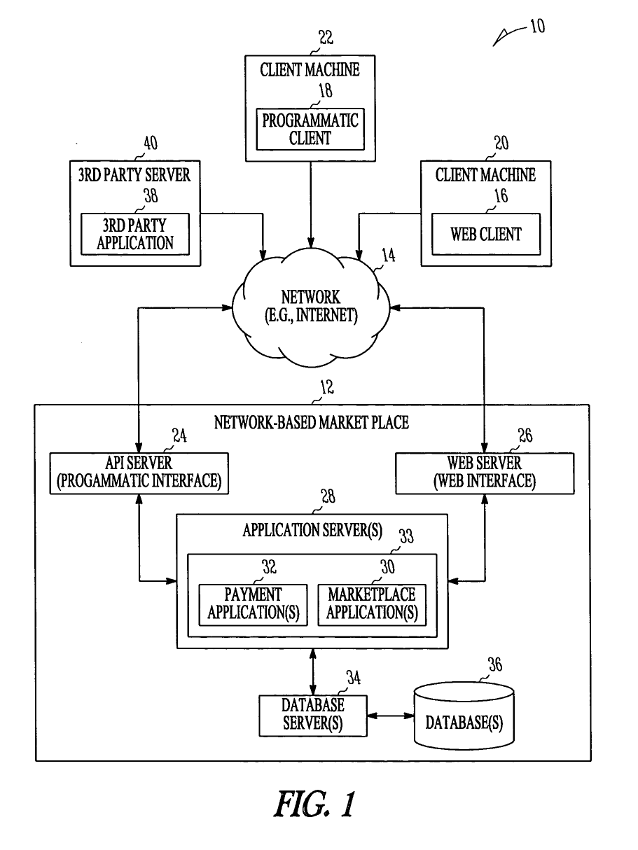

FIG. 1 is a network diagram depicting a system 10, according to one example embodiment of the present invention, having a client-server architecture. A publication system, in the example form of a network-based marketplace 12, provides server-side functionality, via a network 14 (e.g. the Internet) to one or more clients. FIG. 1 illustrates, for example, a web client 16 (e.g. a browser, such as the Internet Explorer browser developed by Microsoft Corporation of Redmond, Wash. State), and a programmatic client 18 executing on respective client machines 20 and 22.

Turning specifically to the network-based marketplace 12, an Application Program Interface (API) server 24 and a web server 26 are coupled to, and provide programmatic and web interfaces respectively to, one or more application servers 28. The application servers 28 host one or more marketplace applications 30 and payment applications 32 (collectively the marketplace and payment applications 33). The application servers 28 are, in turn, shown to be coupled to one or more database servers 34 that facilitate access to one or more databases 36.

The marketplace applications 30 provide a number of marketplace functions and services to users that access the marketplace 12. The payment applications 32 likewise provide a number of payment services and functions to users. The payment applications 30 may allow users to quantify for, and accumulate, value (e.g. in a commercial currency, such as the U.S. dollar, or a proprietary currency, such as “points”) in accounts, and then later to redeem the accumulated value for products (e.g. goods or services) that are made available via the marketplace applications 30. While the marketplace and payment applications 30 and 32 are shown in FIG. 1 to both form part of the network-based marketplace 12, it will be appreciated that, in alternative embodiments of the present invention, the payment applications 32 may form part of a payment service that is separate and distinct from the marketplace 12.

Further, while the system 10 shown in FIG. 1 employs a client-server architecture, the present invention is of course not limited to such an architecture, and could equally well find application in a distributed, or peer-to-peer, architecture system. The various marketplace and payment applications 33 could also be implemented as standalone software programs, which do not necessarily have networking capabilities.

The web client 16, it will be appreciated, accesses the various marketplace and payment applications 33 via the web interface supported by the web server 26. Similarly, the programmatic client 18 accesses the various services and functions provided by the marketplace and payment applications 33 via the programmatic interface provided by the API server 24. The programmatic client 18 may, for example, be a seller application (e.g. the TurboLister application developed by eBay Inc., of San Jose, Calif.) to enable sellers to author and manage listings on the marketplace 12 in an off-line manner, and to perform batch-mode communications between the programmatic client 18 and the network-based marketplace 12.

FIG. 1 also illustrates a third party application 38, executing on a third party server machine 40, as having programmatic access to the network-based marketplace 12 via the programmatic interface provided by the API server 24. For example, the third party application 38 may, utilizing information retrieved from the network-based marketplace 12, support one or more features or functions on a website hosted by the third party. The third party website may, for example, provide one or more promotional, marketplace or payment functions that are supported by the relevant applications of the network-based marketplace 12.

### Marketplace Applications

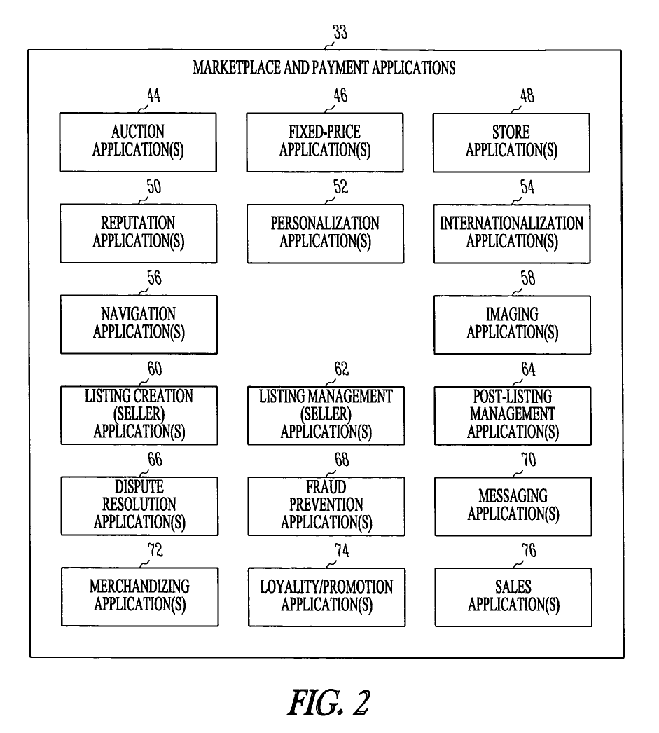

FIG. 2 is a block diagram illustrating multiple marketplace and payment applications 33 that, in one example embodiment, are provided as part of the network-based marketplace 12 of FIG. 1. The marketplace 12 may provide a number of listing and price-setting mechanisms whereby a seller may list goods or services for sale, a buyer can express interest in or indicate a desire to purchase such goods or services, and a price can be set for a transaction pertaining to the goods or services. To this end, the marketplace and payment applications 33 are shown to include one or more auction applications 44 which support auction-format listing and price setting mechanisms (e.g. English, Dutch, Vickrey, Chinese, Double, Reverse auctions etc.). The various auction applications 44 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 46 support fixed-price listing formats (e.g. the traditional classified advertisement-type listing or a catalogue listing) and buyout-type listings. Specifically, buyout-type listings (e.g. including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Store applications 48 allow sellers to group their listings within a “virtual” store, which may be branded and otherwise personalized by and for the sellers. Such a virtual store may also offer promotions, incentives and features that are specific and personalized to a relevant seller.

Reputation applications 50 allow parties that transact utilizing the network-based marketplace 12 of FIG. 1 to establish, build and maintain reputations, which may be made available and published to potential trading partners. Consider that where, for example, the network-based marketplace 12 supports person-to-person trading, users may have no history or other reference information whereby the trustworthiness and credibility of potential trading partners may be assessed. The reputation applications 50 allow a user, for example through feedback provided by other transaction partners, to establish a reputation within the network-based marketplace 12 over time. Other potential trading partners may then reference such a reputation for the purposes of assessing credibility and trustworthiness.

Personalization applications 52 allow users of the marketplace 12 to personalize various aspects of their interactions with the marketplace 12. For example a user may, utilizing an appropriate personalization application 52, create a personalized reference page at which information regarding transactions to which the user is (or has been) a party may be viewed. Further, a personalization application 52 may enable a user to personalize listings and other aspects of their interactions with the marketplace 12 and other parties.

Internationalization applications 54 allow in one embodiment, the network-based marketplace 12 may support a number of marketplaces that are customized, for example, for specific geographic regions. A version of the marketplace 12 may be customized for the United Kingdom, whereas another version of the marketplace 12 may be customized for the United States. Each of these versions may operate as an independent marketplace, or may be customized (or internationalized) presentations of a common underlying marketplace.

Navigation of the network-based marketplace 12 may be facilitated by one or more navigation applications 56. For example, a search application enables key word searches of listings published via the marketplace 12. A browse application allows users to browse various category, catalogue, or inventory data structures according to which listings may be classified within the marketplace 12. Various other navigation applications may be provided to supplement the search and browsing applications.

In order to make listings, available via the network-based marketplace 12, as visually informing and attractive as possible, the marketplace and payment applications 33 may include one or more imaging applications 58 utilizing which users may upload images for inclusion within listings. An imaging application 58 also operates to incorporate images within viewed listings. The imaging applications 58 may also support one or more promotional features, such as image galleries that are presented to potential buyers. For example, sellers may pay an additional fee to have an image included within a gallery of images for promoted items.

Listing creation applications 60 allow sellers conveniently to author listings pertaining to goods or services that they wish to transact via the marketplace 12, and listing management applications 62 allow sellers to manage such listings. Specifically, where a particular seller has authored and/or published a large number of listings, the management of such listings may present a challenge. The listing management applications 62 provide a number of features (e.g. auto-relisting, inventory level monitors, etc.) to assist the seller in managing such listings. One or more post-listing management applications 64 also assist sellers with a number of activities that typically occur post-listing. For example, upon completion of an auction facilitated by one or more auction applications 44, a seller may wish to leave feedback regarding a particular buyer. To this end, a post-listing management application 64 may provide an interface to one or more reputation applications 50, so as to allow the seller conveniently to provide feedback regarding multiple buyers to the reputation applications 50.

Dispute resolution applications 66 provide mechanisms whereby disputes arising between transacting parties may be resolved. For example, the dispute resolution applications 66 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 68 implement various fraud detection and prevention mechanisms to reduce the occurrence of fraud within the marketplace 12.

Messaging applications 70 are responsible for the generation and delivery of messages to users of the network-based marketplace 12, such messages for example advise users regarding the status of listings at the marketplace 12 (e.g. providing “outbid” notices to bidders during an auction process or to provide promotional and merchandising information to users). In one embodiment, the messaging applications 70 may include a communications module and a processing module to communicate and process dynamic marketing text.

Merchandising applications 72 support various merchandising functions that are made available to sellers to enable sellers to increase sales via the marketplace 12. The merchandising applications 72 also operate the various merchandising features that may be invoked by sellers, and may monitor and track the success of merchandising strategies employed by sellers.

The network-based marketplace 12 itself, or one or more parties that transact via the marketplace 12, may operate loyalty programs that are supported by one or more loyalty/promotions applications 74. For example, a buyer may earn loyalty or promotions points for each transaction established and/or concluded with a particular seller, and be offered a reward for which accumulated loyalty points can be redeemed.

Sales applications 76 support various sales functions that are made available to sellers to enable the sellers to increase their sales in the marketplace 12. For example, the sales applications 76 may receive sales information and item information that may be used to schedule sales, start sales, and end sales.

### Data Structures

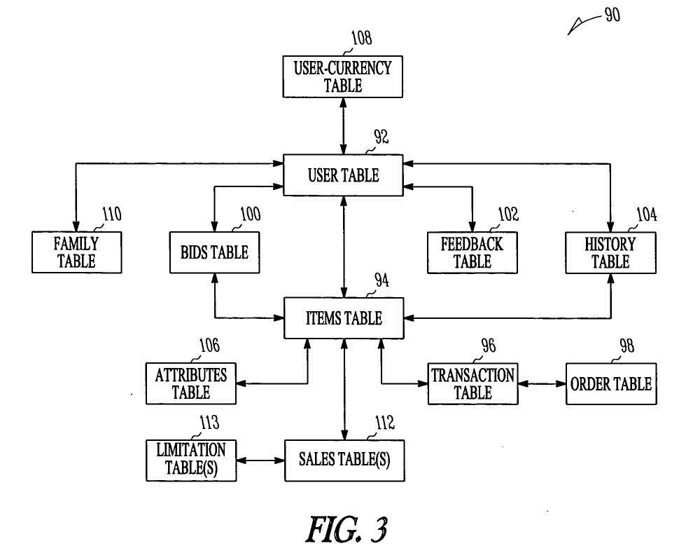

FIG. 3 is a high-level entity-relationship diagram, illustrating various tables 90 that may be maintained within the databases 36 of FIG. 1, and that are utilized by and support marketplace and payment applications 33 of FIG. 1. A user table 92 contains a record for each registered user of the network-based marketplace 12, and may include identifier, address and financial instrument information pertaining to each such registered user. A user may, it will be appreciated, operate as a seller, a buyer, or both, within the network-based marketplace 12. In one example embodiment invention, a buyer may be a user that has accumulated value the value may be tracked in the user currency table 108 (e.g. commercial or proprietary currency), and is then able to exchange the accumulated value for items that are offered for sale by the network-based marketplace 12.

The tables 90 also include an items table 94 in which are maintained item records for goods and services that are available to be, or have been, transacted via the marketplace 12. Each item record within the items table 94 may furthermore be linked to one or more user records within the user table 92, so as to associate a seller and one or more actual or potential buyers with each item record.

A transaction table 96 contains a record for each transaction (e.g. a purchase transaction) pertaining to items for which records exist within the items table 94.

An order table 98 is populated with order records, each order record being associated with an order. Each order, in turn, may be with respect to one or more transactions for which records exist within the transactions table 96.

Bid records within a bids table 100 each relate to a bid received at the network-based marketplace 12 in connection with an auction-format listing supported by an auction application 44 of FIG. 2. A feedback table 102 is utilized by one or more reputation applications 50 of FIG. 2, in one example embodiment, to construct and maintain reputation information concerning users. A history table 104 maintains a history of transactions to which a user has been a party. One or more attributes tables 106 record attribute information pertaining to items for which records exist within the items table 94. Considering only a single example of such an attribute, the attributes tables 106 may indicate a currency attribute associated with a particular item, the currency attribute identifying the currency of a price for the relevant item as specified in by a seller.

Sales tables 112 may be utilized by one or sales applications 76 to store and retrieve information to facilitate the scheduling, starting, and ending of sales. The sales may be promoted by sellers who utilize the network-based marketplace to increase sales of their items in the network-based marketplace 12. A limitation tables 113 may be used to by one or more sales applications 76 to determine if proposed sales violate any service provider or country rules or laws.

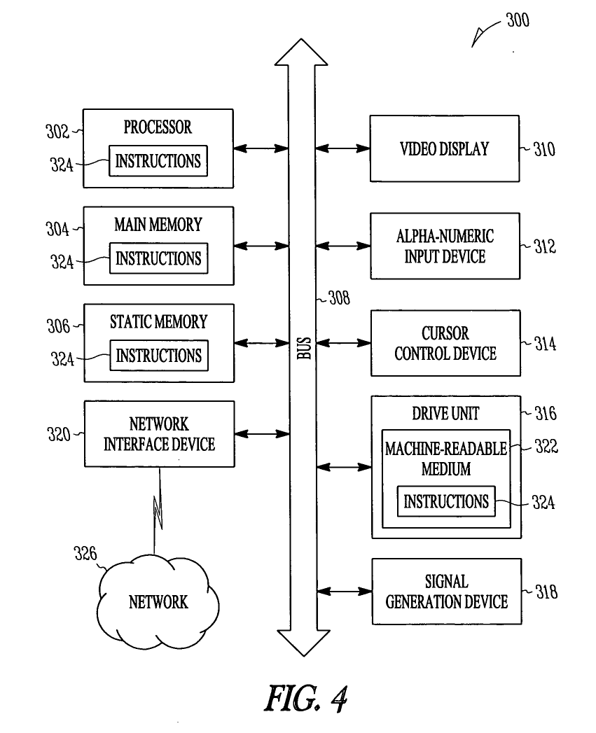

FIG. 4 shows a diagrammatic representation of machine in the example form of a computer system 300 within which a set of instructions, for causing the machine to perform any one or more of the methodologies discussed herein, may be executed. In alternative embodiments, the machine operates as a standalone device or may be connected (e.g. networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g. a central processing unit (CPU) a graphics processing unit (GPU) or both), a main memory 304 and a static memory 306, which communicate with each other via a bus 308. The computer system 300 may further include a video display unit 310 (e.g. a liquid crystal display (LCD) or a cathode ray tube (CRT)). The computer system 300 also includes an alphanumeric input device 312 (e.g. a keyboard), a cursor control device 314 (e.g. a mouse), a disk drive unit 316, a signal generation device 318 (e.g. a speaker) and a network interface device 320.

The disk drive unit 316 includes a machine-readable medium 322 on which is stored one or more sets of instructions (e.g. software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 322 is shown in an example embodiment to be a single medium, the term “machine-readable medium” should be taken to include a single medium or multiple media (e.g. a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

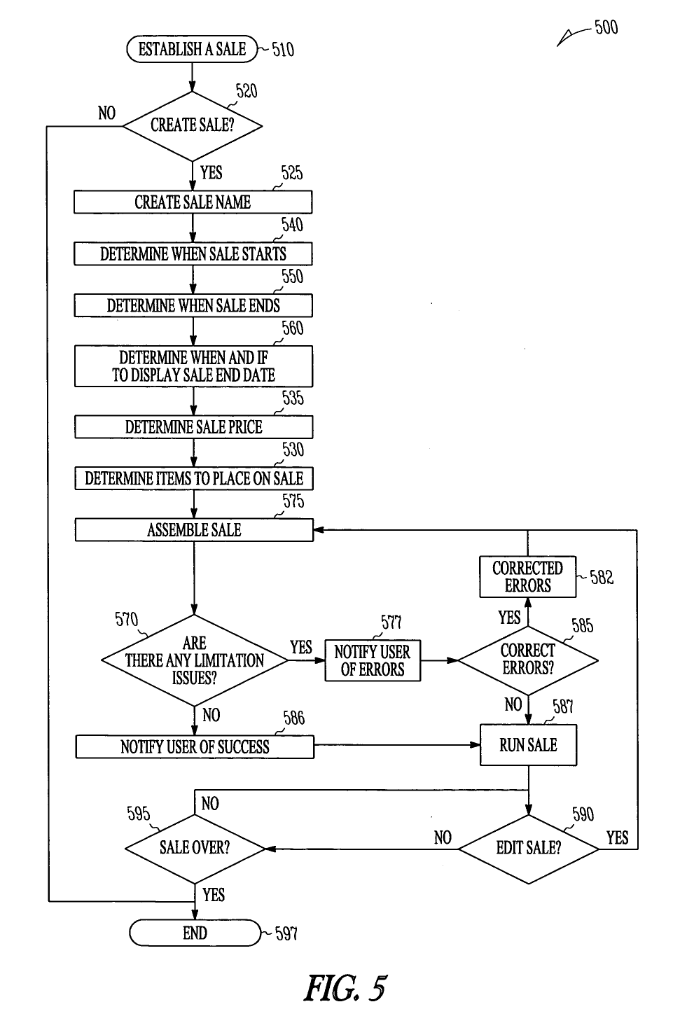

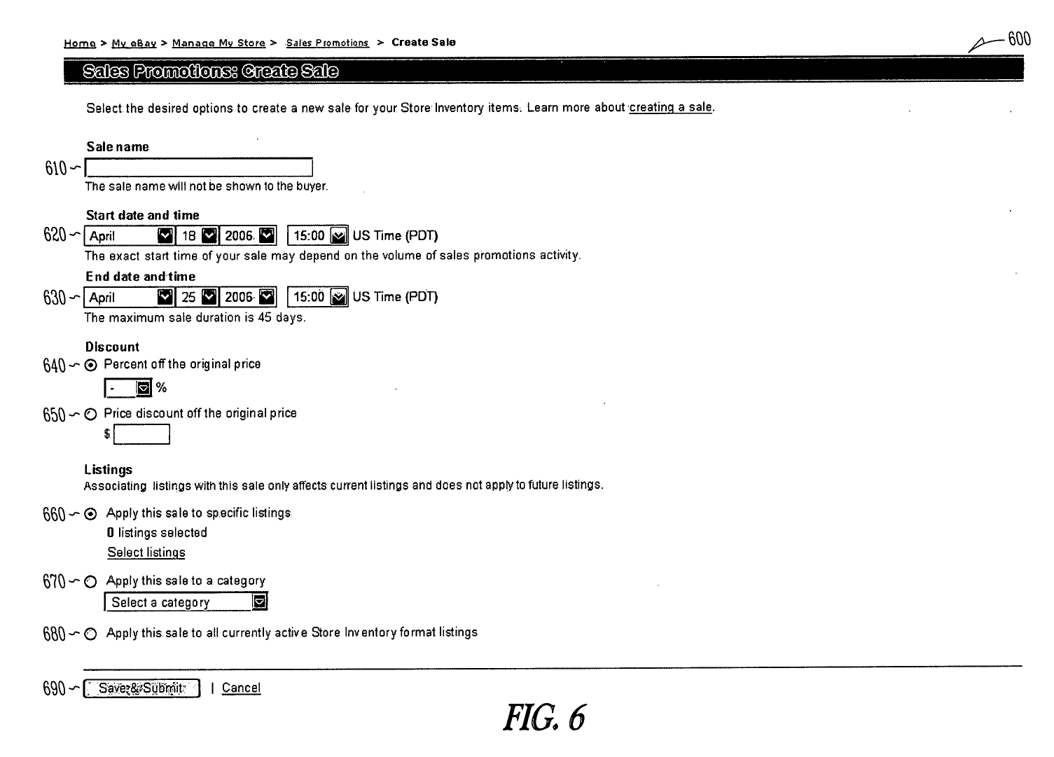

FIG. 5 is flowchart illustrating a method 500 for setting up and monitoring a sale on a network-based market place. Activity 510 may be to initiate a sales process. Activity 520 may be to determine if a sale will be established by a user. If a sale is to be established, a screen such as that of FIG. 6 may appear indicating that a seller wishes to establish a sale. FIG. 6 is a screen shot of a sales creation page according to an example embodiment. Activity 525 may be for the user to select a name for the sale using. The sale initiation screen of FIG. 6 may allow the user to select the name of the sale 610. The sale name may be any name the user selects, however the limitations process 570 may prevent the use of names that are deemed offensive. The limitation process 570 may verify the proposed sale against a limitation database which may be found in the marketplace and payment applications 33 of FIG. 2.

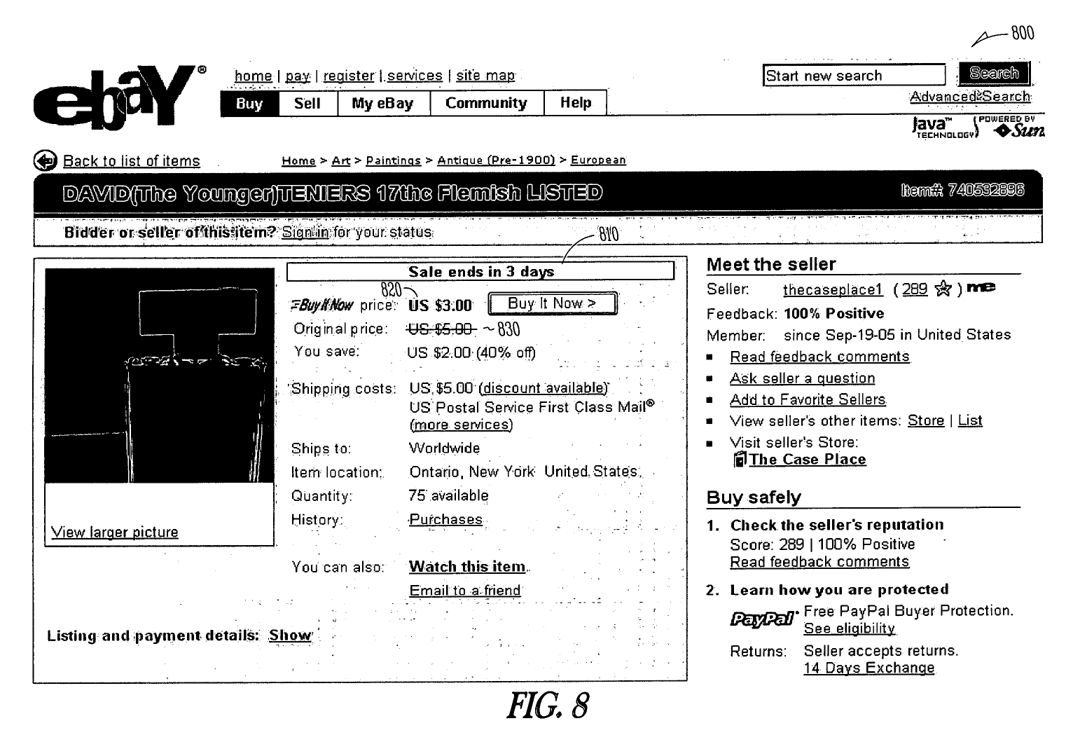

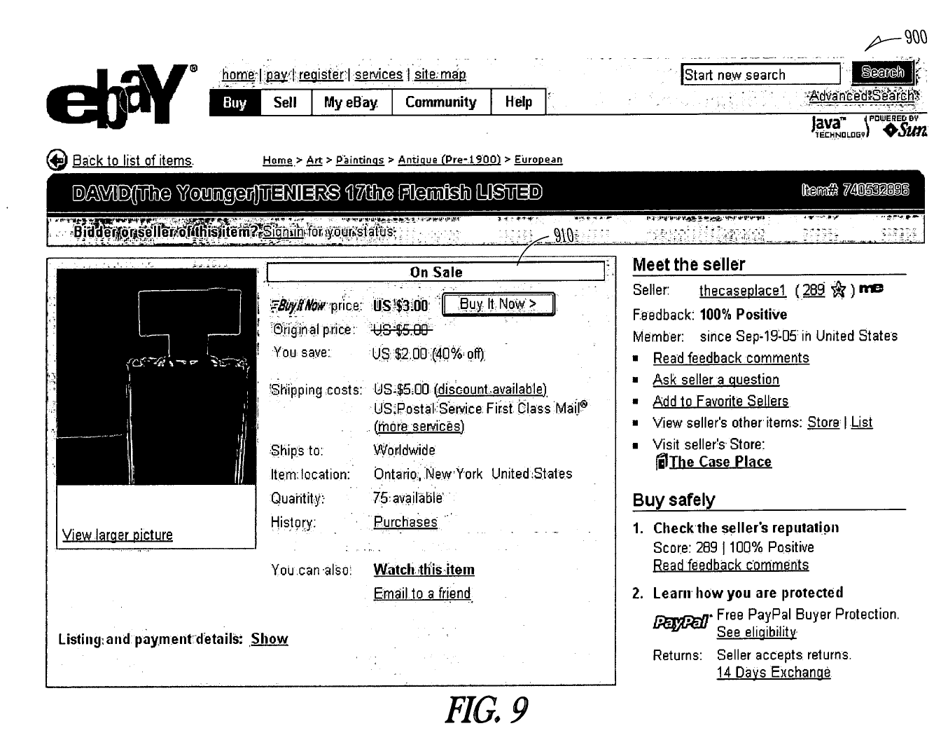

Activity 540 may be to determine when a sale will be initiated. Activity 550 may be to determine the date when the sale ends or the duration of the sale. The sale date may for example include the start date 620 and the end date 630 as shown in FIG. 6. It should be noted that the sale may begin on the date the sale was created or some time in the future based on seller preference. Activity 560 may be to determine if a sale ending date 810, such as illustrated in FIG. 8, should be displayed. Activity 560 may be open for the seller to determine to display the banner 810 or may be a decision the service provider has made. FIG. 8 is an example embodiment of a product listing available to a buyer. The sale ending date or remaining duration 810 may be illustrated for the buyer to see when browsing for various products available. FIG. 9 is another example embodiment of a product listing available to a buyer. As an alternate embodiment, the a banner 910 may simply indicate that the item is “on sale”.

Activity 535 may be to determine a sales price for items selected in the prior activity. For example in FIG. 6 a sales reduction line 640 allows the seller to select the percentage a sale item will be reduced. The sale price line 650 may provide for a dollar amount the items are reduced.

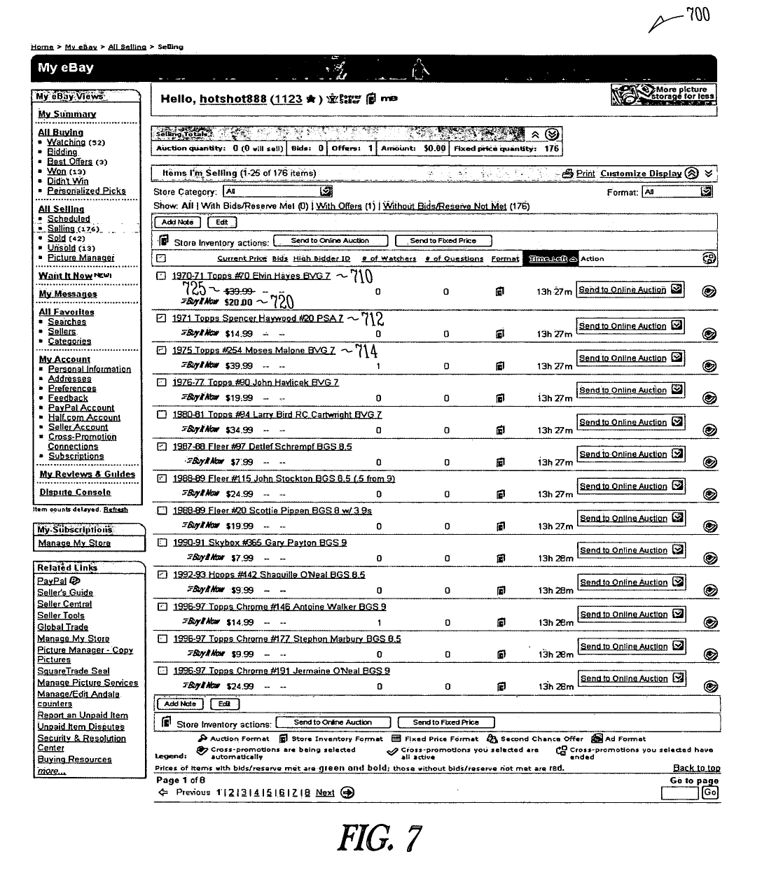

Activity 530 may be to determine which items to place on sale. A seller may be able to place only their store inventory format and fixed price items “on sale,” according to one embodiment. The seller may be able to select a specific listing of sale items 660 by accessing a listing such as the one shown in FIG. 7. FIG. 7 is an example listing of products a seller has made available for sale. The seller may also be able to select a category 670, such as a type of product. The seller may also select to have all inventory 680 on sale. FIG. 7 illustrates a screen shot available to a seller to allow the seller to select items to place on sale. Screen 700 may provide a listing of items listed for sale by a seller such as items 710, 712, and 714. When an item is selected the sale price 720 may be indicated and the original price 725 may be displayed with a strike through to indicate that that is not the current price.

It should be noted that activities 525, 530, 535, 540, 550, and 560 may be performed in any order. These activities are completed by filling in the appropriate information found on screen 600 of FIG. 6. When all of the information has been inserted the submit button 690 is selected.

Activity 575 of FIG. 5 may be to assemble the sale based on the information provided in the prior operations. When the sale is assembled, activity 570 may be to determine if there are limitations on the sale. For example, must a sale last at least a set number of days? Is a one day sale permitted, is there a minimum discount percentage, a maximum discount percentage or a period of time before a sale may be deactivated? There may also be limitations on the size of the sale. For example, to conduct a sale at least a set number of items must be on sale. An alternative may be a maximum number of items that may be on sale at one time. There may also be limitations on how long or short a sale may be. These limitations may be set by the service provider to assure consistency across the service or to prevent overburdening the servers. The sale may also have limitation based on country or state laws for either the user, the seller or both. For example, a user in Germany may only be permitted to place an item on sale once it has been sold for a certain number of days at the full price. As an example, in one embodiment, before performing the save actions, the following checks may be performed. The sales start date and end date should be checked to see if they meet the specified criteria as mentioned in the error table below (TABLE 1). If a price discount has been selected, check to see if every item added to the sale meets the discount criteria as specified in the error table below. Check that items are not in another concurrent sale. If an item is in a sale that overlaps another sale, give the user an info message on each item as defined in the table below. If the seller chooses to continue and add this sale to the item, the item may be removed from the other sale. This action may not only be for current sales, but also for future sales. For example, if an item is already in Sale A that starts September 8^{th} and ends September 15^{th}, and the seller attempts to add the item into Sale B from September 15^{th}-September 22^{nd}, the user may be prompted that the item may not exist in two concurrent sales. They may have the choice to remove it from Sale A and put it in Sale B. Check listing date to see if the listing may be active at the current price (or a higher price) for the appropriate amount of time before it goes on sale. This may be configurable by geographic region (e.g., country). This essentially doesn't allow sellers to put items on sale if they have recently raised their price.

If over 200 items are in the sale, the service provider may process the seller's request asynchronously. If the service providers are processing listings asynchronously, the service provider may notify the seller via a manage sales page 600 if it has completed or not. Table 1 provided below, provides a listing of potential limitations.

TABLE 1

| | | Info/ | | |
|---|---|---|---|---|
| Message | Use case | Error | Type | Content |
| Enter Required Fields | If any of the following fields are left | Error | Inline | Please enter the correct information |
| | blank | | | in the highlighted fields. |
| | Sale Name | | | Sale Name. Please enter this |
| | % off or $ amount off | | | information. |
| | | | | Discount. Please enter this |
| | | | | information. |
| | | | | Next to each field that may be |
| | | | | missing information, include the |
| | | | | following text: |
| | | | | Please enter this information |
| Enter Required Fields | The user selects the option to enter a | Error | Inline | Please enter the correct information |
| | price discounts rather than a % | | | in the highlighted fields. |
| | discount, and the information may be | | | Sale Name. Please enter this |
| | entered in the incorrect format. Rules | | | information. |
| | for the price discount | | | Discount. Please enter this |
| | Only positive numbers allowed | | | information. |
| | No more than 2 decimal places | | | Next to each field that may be |
| | allowed. | | | missing information, include the |
| | Invalid Characters. Invalid | | | following text: |
| | characters include everything except | | | Please enter this information |
| | 0-9 and “.” | | | |
| Duration of sale is longer | The seller has selected a duration for | Error | Inline | You have exceeded the maximum |
| than allowed limit | the sale that is over the countries | | | duration of [X] days allowed for a |
| | allowed limit | | | sale. |
| | | | | [X] is defined in the appendix |
| Duration of sale is shorter | The seller has selected a duration for | Error | Inline | The minimum duration of a sale is |
| than allowed limit | the sale that is shorter than the | | | [X] days. |
| | countries allowed limit | | | [X] is defined in the appendix |
| Listings are in 2 sales | The user has added an item into a | Info | Manage | X listings were in a concurrent sale |
| | sale that currently is associated with | | Sales Page | and may be removed from that sale to |
| | other sales during the same time | | | be put in this one. |
| | frame. (Note this include any 1 day | | | X represents the number of listings |
| | of overlap) | | | that are in another active sale this |
| | | | | rule. |
| May not raise the price of | The price of the listings has been | Error | Manage | X listings may not be put on sale |
| an item to put on sale | changed within the last XX days or | | Sales Page | because they are newly listed, or the |
| | the item has just been put up for sale. | | | price has recently changed. |
| | (Note we may be looking at the start | | | |
| | date of the sale to verify this) Based | | | |
| | on the listing country's settings. | | | |
| Listing violates the | The listing is ending before the sale, | Error | Manage | X listings may be ending before the |
| minimum duration of a | and therefore violates the minimum | | Sales Page | sale ends and violate the minimum |
| sale rule | duration of a sale | | | duration of a sale rule. |
| | | | | X represents the number of listings |
| | | | | that violate this rule. Based on the |
| | | | | listing country's settings. |
| The listing violates the | The seller may receive this error | Error | Manage | X listings violate the minimum |
| listing country's minimum | message if their listing is listed on | | Sales Page | duration of Y allowed for the country |
| duration rule | another site other than where their | | | it is listed on. |
| | store is based, and the sale duration | | | X represents the number of listings |
| | is greater than the allowed limit for | | | that violate this rule. |
| | the country site that the item has | | | Y represents the country's minimum |
| | been listed on. | | | duration as set in the appendix |
| | We may give this error message for | | | |
| | each different country site that has | | | |
| | this listing violation. | | | |
| The listings violate the | The seller may receive this error | Error | Manage | X listings violate the maximum |
| listing country's | message if their listing is listed on | | Sales Page | duration allowed of Y for the country |
| maximum duration rule | another site other than where their | | | it is listed on. |
| | store is based, and the sale duration | | | X represents the number of listings |
| | is greater than the allowed limit for | | | that violate this rule. Based on the |
| | the country site that the item has | | | listing country's settings. |
| | been listed on. | | | Y represents the country's maximum |
| | | | | duration as set in the appendix |
| Listings are in multiple | We may present this message if the | Info | Manage | You have items in multiple |
| currencies Info message | seller has chosen to discount listings | | Sales Page | currencies. The amount off you have |
| | by a fixed amount, and the items are | | | chosen may be applied based on the |
| | listed in a currency different from | | | listing country's currency. |
| | their Store location's currency. | | | |
| Editing/Listing Limit has | The Seller has exceeded the limit of | Error | Inline | If editing an active sale: |
| been exceeded | the number of times an active Sale | | | You have exceeded the number of |
| | changes. This includes: | | | listings that you may change within |
| | Starting a Sale (including a | | | one day to active sales ([X]). These |
| | scheduled sale) | | | changes include adding listings into |
| | Editing the price discounts | | | existing active sales, editing price |
| | of a sale | | | discounts to active sales and |
| | Adding an item to a sale | | | scheduling a sale for today. |
| | Sellers may be given a cap of the | | | If scheduling a sale that |
| | number of listings they may change | | | exceeds the limit: |
| | in a particular day for active sales | | | You have exceeded the number of |
| | (excluding removing listings from a | | | listings that you may schedule to be |
| | sale). For example, if we set the limit | | | on sale in one day ([X]). Note: |
| | at 5,000 and a seller has Sale A | | | Editing active sales count toward |
| | starting on June 26^{th} with 5000 | | | your daily limit. |
| | listings they may be fine. However, | | | [X] represents the listing limit of the |
| | if a seller then tries to change the % | | | Store site subscription and tier. |
| | off on another sale with at least one | | | [CR #3] |
| | listing, we may prevent them from | | | |
| | doing this because they have hit their | | | |
| | daily limit already. | | | |
| | We may prevent the last sale that has | | | |
| | been saved from doing the | | | |
| | edits/scheduling a sale. | | | |
| The sale is scheduled | The start date of the sale is > than 6 | Error | Inline | You may not schedule a sale more |
| more than 6 months in the | months from the current date. | | | than 6 months in the future. |
| future | | | | |

The limitations may be checked based on the country that the item has been listed on, according to one embodiment. For example, if a US Storeowner lists on the German site, the item may pass the German requirements. These checks may not be performed for all countries that the listing appears, rather the site on which the item may be listed. Listing level checks may not occur for sales that occur on the past. This may save processing time, as these sales may be processed only if the sales dates are set to the future. These checks may occur on items that have changed. For example, if a seller adds new items and the seller saves the sale, the service provider may check those items. However, if an item already exists in a sale, the minimum duration check may not occur on that item.

Table 2 presents potential limitations for various countries that may be available. As seen the table may provide information regarding current sales and minimums and maximums proscribed by laws and by service provider.

TABLE 2

| | | | | | | | Minimum | | | | |
|---|---|---|---|---|---|---|---|---|---|---|---|
| | | | | | | | Time at | | Listing/ | Listing/ | Listing/ |
| | | | | | Minimum | Minimum | current | Edit Sale | Editing | Editing | Editing |
| | Display | Maximum | Minimum | | Time | time Listed | Price | Allowed | Limit per | Limit per | Limit per |
| | Days | Duration | Duration | Maximum | between | before item | before | when | day | day | day |
| | left in | of Sale (in | of Sale (in | % off | sales (in | may go on | Item may | active | Basic | Featured | Anchor |
| | Sale | days) | days) | Items | days) | Sale | go on sale | (Y/N) | Subscription | Subscription | Subscription |
| US | 7 | 45 | 1 | 75 | 1 | 0 | 0 | Y | 5000 | 5000 | 5000 |
| DE | 14 | 14 | 3 | 50 | 7 | 7 | 7 | N | 5000 | 5000 | 5000 |
| IN | 7 | 30 | 1 | 75 | 1 | 0 | 0 | Y | 5000 | 5000 | 5000 |
| AU | 10 | 45 | 1 | 75 | 7 | 7 | 7 | N | 5000 | 5000 | 5000 |
| TW | 7 | 30 | 1 | 90 | 1 | 1 | 1 | Y | 5000 | 5000 | 5000 |
| CH | 14 | 14 | 3 | 50 | 7 | 7 | 7 | N | 5000 | 5000 | 5000 |
| AT | 14 | 14 | 3 | 50 | 7 | 7 | 7 | N | 5000 | 5000 | 5000 |

*Unless Otherwise Noted, countries may assume the US value

If the listings are in two sales the seller may be presented with an error message. The listings may be listed at a price for the item before a sale may take effect. These sales may be configurable per country. It may be useful to check only if the price has been raised within a certain period of time and block only listings in which the price has been raised. In another situation an error may occur if the listing may be ending before the sale ends, therefore breaking the minimum duration rule. This may be checked on an item by item basis. If the listing ends before the sale ends, the minimum duration as set in the appendix may not be violated. For example, the sale is from May 1, 2006-May 10, 2006, and the listing ends on May 3, 2006, the minimum duration is three days, the sale may not be allowed on the listing. An error may occur if the listing violates the listing country's minimum duration rule. The seller may receive an error message if their listing is listed on another country site other than where their store is based, and the sale duration is greater than the allowed limit for the country site that the item has been listed on.

Another error may be that the listings violate the listing country's maximum duration rules. The seller may receive an error message if their listing is listed on another site other than where their store is based, and the sale duration is greater than the allowed limit for the country site that the item has been listed on. An error may occur if the listings are in multiple currencies.

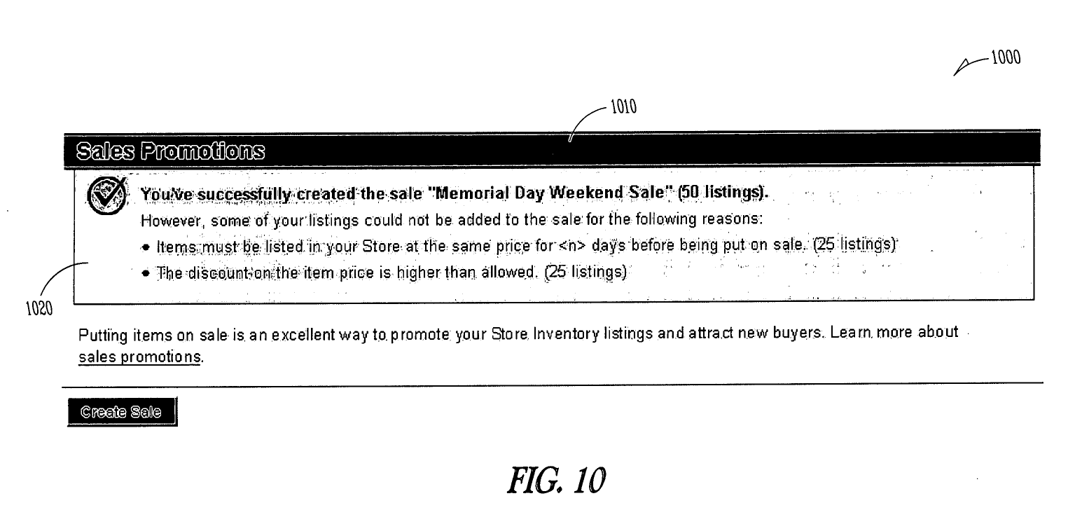

In the event errors are detected, activity 577 may be to notify the seller of the errors. In addition to notifying the seller of the errors, the seller may be notified of limited success. If errors exist an error banner such as banner 1010 of FIG. 10 may be presented on an error screen 1000. The banner 1010 may also indicate or remind the seller of limitations found in table 1 and provide the seller with a listing of errors 1020. FIG. 10 is an error banner utilized to indicate errors in the sale setup according to an example embodiment.

Activity 585 may be for the seller to decide if they wish to correct the errors and add the items that have been excluded to the sale. If the seller does not wish to correct the errors, activity 587 may be to run the sale. If the seller wishes to correct the errors, activity 582 may be to correct the errors. For example, the seller may be brought to a screen such as screen 600 of FIG. 6. Once the errors are corrected activity 575 may be repeated.

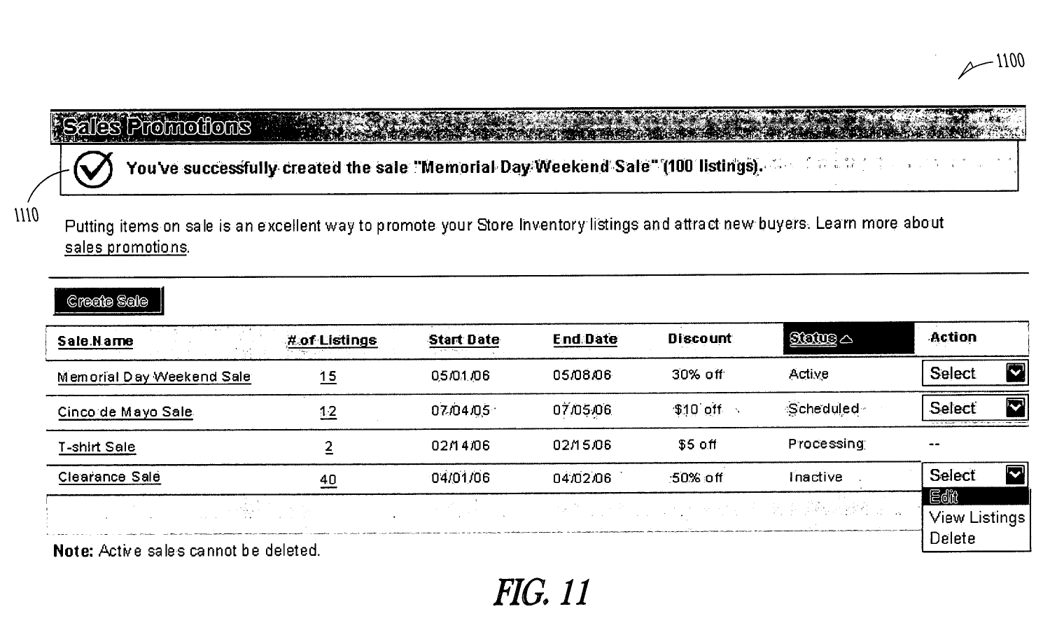

Activity 586 may be to notify the seller that activity 570 did not find any errors. In the event no errors exist or once the errors are corrected, activity 582 may be to notify the seller that the sale has been initiated. This may be via a success screen such as screen 1100 of FIG. 11 with a success banner 1110. FIG. 11 is a success banner utilized to indicate the successful set up of a sale according to an example embodiment. When no errors are detected, activity 587 may be to run the sale.

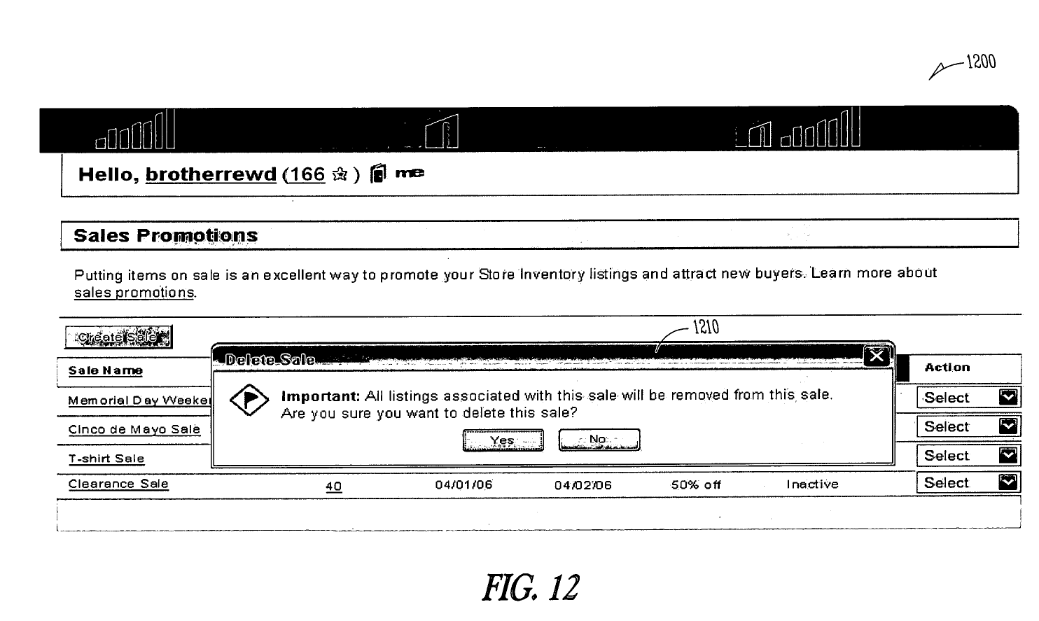

Activity 590 may be for the seller to determine if they wish to edit the sale. To edit the sale the seller may utilize the screen 600 of FIG. 6 to edit the current sale. One of the possible edits may be to end the sale. FIG. 12 illustrates a preemptive sale ending screen 1200 indicating the result of ending the screen with banner 1210 according to an example embodiment. A preemptive end to a sale provided for in activity 590 may need to be run through the limitations activity 570 prior to closing the sale. It may be that the service provider wishes to prevent active sales from termination and thereby ending the sale may be blocked by activity 570. If the sale is edited, activity 575 may be run to reassemble the sale and activity 570 may be initiated to verify the edits do not violate any of the limitations. Sellers may be given a cap of the number of listings they may change in a particular day for active sales (excluding removing listings from a sale), according to one embodiment. For example, if the service provider sets the limit at 1,000 and a seller has sale starting on June 26th with 1000 listings they may be fine. However, if a seller then tries to change the percentage off on another sale with at least one listing, the service provider may prevent them from doing this because they have hit their daily limit already. The service provider may always prevent the last sale that has been saved from doing the edits/scheduling a sale, according to one embodiment.

If the sale is not edited or ended in activity 595 may determine if the sale is over. If the sale is not over activity 590 may be made available until it is over. In affect, activities 590 and 595 are a wait period until the end of the sale unless activity 590 is activated by the seller. When the sale ends as determined by activity 595, activity 597 is to end method 500.

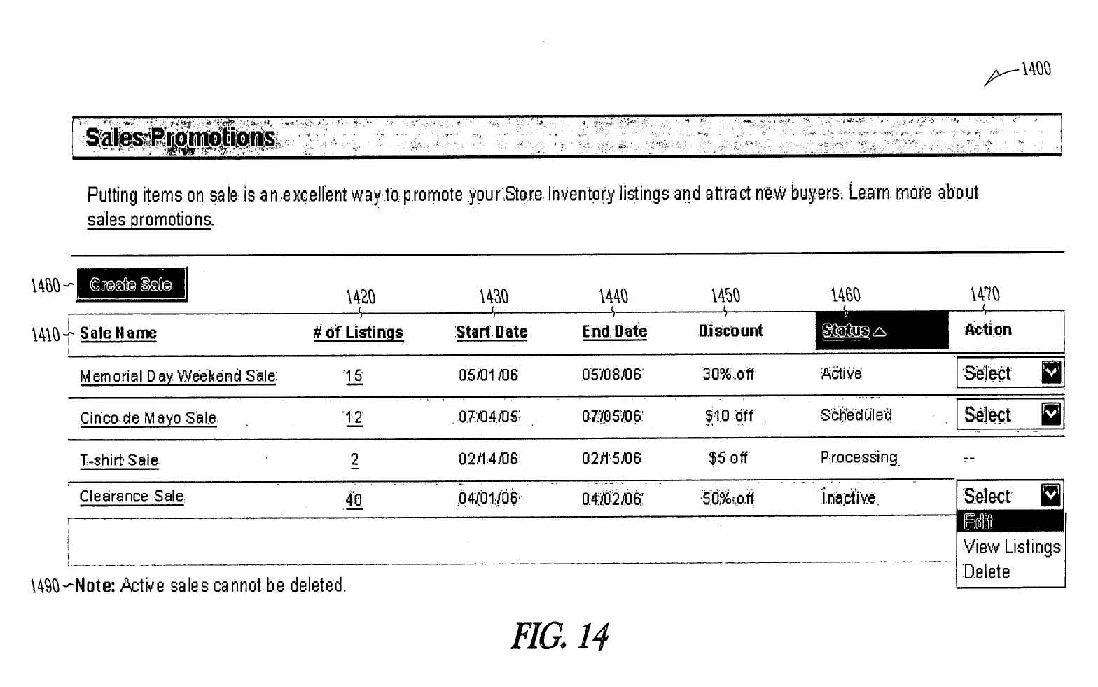

To permit the seller to edit sales and manage sales it may be that a manage sales screen 1400 may be provided of FIG. 14. FIG. 14 is an example embodiment of a screen for managing sales. The manage sales screen 1400 may include a listing of sales 1410, the number of items on sale 1420, the start date 1430, the end date 1440, the discount 1450 the status of the sale 1460. The manage sales screen 1400 may also include an action button 1470 permitting the seller to edit a sale. In addition the manage sales screen 1400 may include a create sale button 1480 to permit a seller to start a new sale. In addition limitations 1490 may be presented to remind the seller of limitations when editing sales.

Once a sale is created the sale will be presented to the buyer. According to one embodiment, unless otherwise specified, the sale price may be the price that appears anywhere price is currently displayed. The sale price may be the true “actual” price, and is what needs to be reflected as the standard item price in the marketplace, (e.g. item-related emails, merchandising widgets, all data warehouse price fields, etc.) for the duration of the sale. In both the marketplace core search and marketplace express search, the sale price may appear as the price with no special visual treatment.

According to one embodiment, If the seller chooses to put the item on sale by default display the following on the screen 800 of FIG. 8. The screen 800 may include a banner 810 indicating the item is on sale and in one embodiment the date the sale will end. In the event the sale ends on that day it may stat the sale ends “Today” or the number of hours remaining in the sale. If the sale is for an extended period of time, as shown in FIG. 9, the screen 900 may simply display that the item is on sale in banner 910

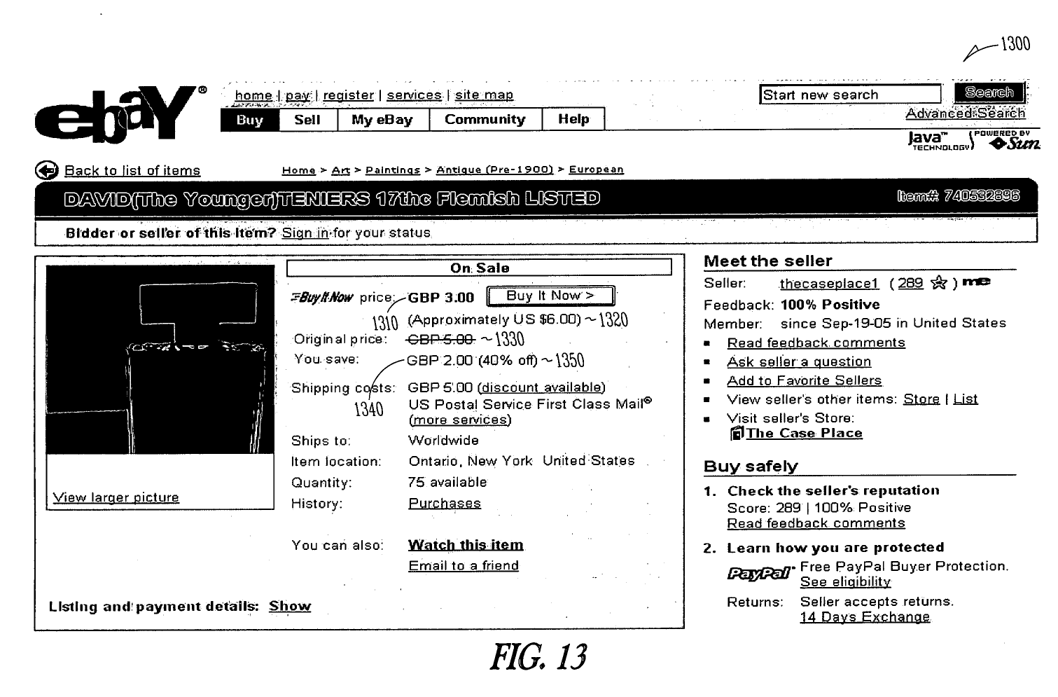

The sale price 820 may also be displayed. This may be the actual item price, the system may calculate this for the seller, who may be entering a % or dollar discount amount for sale items. If the item is in a foreign currency, the standard currency conversion message below the sales price may be displayed. “(Approximately XXXX)”. FIG. 13 is an example embodiment of a product listing available to a buyer.

As shown in FIG. 13, the screen 1300 may concurrently indicate the sale price 1310, the approximate price in US currency 1320, the original price 133 (e.g. struck out or otherwise indicated as no longer current), the discount 1340 and the percent savings 1350. Displaying both the sale price and the original price may be effective in visually communicating the discounted nature of the sale price to a potential buyer. Further, displaying the original price as a strikeout may enhance this visual effect.

Thus, a method and system to schedule a sale on a network-based marketplace have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b) requiring an abstract that will allow the reader to quickly ascertain the nature of the technical disclosure. It is submitted with the understanding that it will not be used to interpret or limit the scope or meaning of the claims. The above description and figures illustrate embodiments of the invention to enable those skilled in the art to practice the embodiments of the invention. Thus the following claims are hereby incorporated into the Detailed Description, with each claim standing on its own as a separate embodiment.

What is claimed is:

1. A method including:
receiving sale information that includes item information that identifies a an item offered for sale by a first seller on a network-based marketplace; and
scheduling a sale based on the sale information, the sale to begin at a first time and end at a second time, the first time associated with a reduction of a price of the item to a discounted price of the item, the second time associated with a restoration of the price for the item.

2. The method of claim 1, wherein the network-based marketplace includes a plurality of sellers that includes the first seller.

3. A computer-implemented method, comprising:
creating a sale on a network for an item having a standard price presented to a buyer;
setting a reduction in the standard purchase price to create a sale price;
setting a start date for the sale at which the item is offered at the sale price; and
setting an end date for the sale at which the item is offered at the standard price.

4. The computer implemented method of claim 3, wherein the sale price is a percentage of the standard price.

5. The computer implemented method of claim 3, wherein the sale price is a reduction from the standard price by a fixed amount.

6. The computer-implemented method of claim 3, further comprising verifying the sale with a limitations database.

7. The computer-implemented method of claim 6, wherein the limitations database includes a minimum duration of time from the start date to the end date.

8. The computer-implemented method of claim 6, wherein the limitations are geographically specific based on the location of the seller.

9. The computer-implemented method of claim 6, wherein the limitations are geographically specific based on the location of the buyer.

10. The computer-implemented method of claim 6, wherein the limitations include determining if the item is listed in another sale.

11. The computer-implemented method of claim 6, further comprising notifying the seller of an error.

12. The computer-implemented method of claim 11, further comprising correcting the error and verifying the sale with the limitations database.

13. The computer-implemented method of claim 6, further comprising allowing the sale to proceed based on verification of the item using the limitations database.

14. The computer-implemented method of claim 3, further comprising selecting the item from a list of items.

15. The computer-implemented method of claim 3, further comprising selecting the item by category.

16. A machine-readable medium comprising instructions, which when executed by one or more processors, cause the one or more processors to perform the following operations:
presenting a seller with a list of items available at an original price for the seller to make available at a reduced price;
establishing a start date on which at least one of the items will be made available at the reduced price;
establishing an end date on which at least one of the items will be made available at the original price; and
presenting the at least one item at the reduced price from the start date to the end date.

17. The machine-readable medium of claim 16, further comprising
reviewing a limitations table;
notifying the seller of violations of the limitations table; and
providing a method to amend one of the items, the start date or the end date.

18. The machine-readable medium of claim 17, wherein the limitations table includes geographic laws.

19. A system, comprising:
a computer to communicatively couple to a computer network; and
a sale application to support sale functions adapted to assist sellers select items, set a sale start date and a sale end date.

20. The system of claim 19 further comprising a limitations table.
